(19) United States
(12) Patent Application Publication
(10) Pub. No.: US 2001/0034768 A1
(43) Pub. Date: Oct. 25, 2001

(54) Inter vehicle communication system

(76) Inventors: David Bain, Arlington, VA (US); John Ray Paseur, McLean, VA (US)

Correspondence Address: BLACKMON IPS & LAW OFFICE, 2101 CRYSTAL PLAZA ARCADE , PMB #289, ARLINGTON, VA, 22202, US

(21) Appl. No.: 09/757,651

(22) Filed: Jan. 11, 2001

Related U.S. Application Data
(60) Provisional application No. 60/175,258, filed on Jan. 10, 2000.

(51) Int. Cl. G06F 15/16; G06F 7/00; G06F 17/00

(52) U.S. Cl. 709/206; 709/245; 707/104.1

(57) ABSTRACT

A method and network for transmitting a message from a sender to a recipient wherein the sender has no previous knowledge of the recipient's address. A network is provided for registering a user with an internet service by providing correlating data on the user's e-mail address and vehicle license plate number and other vehicle identifying information. A sender observing a recipient's can send a message to the recipient by logging onto the service and sending a message including the license plate number of the vehicle or other vehicle identifying information. The service will forward the message to the recipient by looking up the vehicle information and providing the corresponding e-mail address to the message and sending to the recipient.

### BACKGROUND OF THE INVENTION

1. Field of the Invention

The present invention relates to a system and method for connecting messages addressed sent from one vehicle (sender) intended for a second vehicle (recipient) without requiring pre-knowledge of the recipient's address information.

2. Description of the Prior Art

Computers are becoming more and more prevalent throughout our technologically advanced society. Even with drivers of passenger vehicles commuting on busier roads with more and more distractions and obstacles, the technology boom is quickly adding more and more internal distractions to the inside of vehicles. Portable telephones are currently the most visible technological distraction for drivers. Minivans are now coming equipped with televisions and video players and video games in the backseat area for the amusement of the passengers. GPS systems and mapping displays are finding their way into our vehicles. Heads-up-displays and night vision systems are beginning to enter the market place as well.

Cars and trucks are also being built now with additional outlets to run more of the external electronics that drivers and passengers are porting with them. The outlets which once were used to run radar detection units are now being used by the ever present computers. Laptops, notebooks, and hand held computers are becoming more and more prevalent as the internet becomes an important method of sending and retrieving vital information. Where individuals once made a telephone call to information to locate phone numbers, now the same individuals are downloading the telephone number off the internet along with the address, map and driving directions to the destination from free sites available on the internet sites.

With the methods available for one person to communicate with another at an all time high, through telephones, faxes, e-mail, chat groups, and a myriad of other sources, there should be a simple way for one person in sight of another vehicle to transmit a message across the vehicles without having to know the identity or address of the other driver to minimize the distractions to the driver.

The current system proposed by the present invention utilizes a central database and service to connect one driver with another driver by a common internet medium. As in-car computers become more prevalent, inter-vehicle e-mail will provide an ideal method of connecting two drivers who were previously unknown to each other. The internet provides a common format standardization for transmitting data which is independent of the operating system, browser, and software being used by both or either of the end computers. A hand held computer operating in a non-DOS (WINDOWS™, MACINTOSH™, etc.) environment can communicate easily with a laptop running in a DOS environment, and vice versa. E-mail and the internet provide common communication standards as well as a relatively “free” transmission medium.

The Inter Vehicle Communication System is an internet based clearinghouse for allowing users to register their e-mail address and to tie the e-mail address to additional personal identifying information such as a vehicle license plate number. This will allow a person connected to the internet to address an e-mail to the registered user by entering visually identifiable information such as a license plate number, rather than having to know the identity of the driver and research the e-mail address from known sources. E-mail sent to the clearinghouse addressed to the vehicle license plate number can be correlated to the particular user's e-mail address through information obtained during registration and be forwarded to the user for review. In this way one driver in sight of a second driver and having no previous knowledge of the driver, the vehicle, or the driver's address can send information to the driver.

### SUMMARY OF THE INVENTION

Accordingly, it is a principal object of the invention to provide an inter vehicle communication system capable of forwarding e-mail from one driver to another driver without requiring the first driver have prior knowledge of the second driver's address.

It is another object of the invention to provide a system for forwarding information from a first driver to a second driver identified solely by the second driver's license plate number, decal information or similar vehicle identifying information.

It is a further object of the invention to provide a method of operation a clearinghouse for registering users by e-mail address and other personal data and identification numbers to allow authorized transmission of messages from one driver to another driver.

Still another object of the invention is to provide a database and computer system capable of storing and retrieving data on members to correlate incoming e-mail messages addressed to a member's vehicle license plate number and forwarding the e-mail to the e-mail address of the member for review by the member.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is flow diagram of the transmission of a message from a first driver to a second driver.

FIG. 2 is a flow diagram of the registration of information with the inter vehicle communication system.

FIG. 3 is a diagram of the a webpage menu structure according to the present invention.

FIG. 4 is a diagrammatic view of a first vehicle browser program in communication with a second vehicle browser program through an Inter Vehicle Communication System according to the present invention.

FIG. 5 is a front plan view of a vehicle decal showing registration information for a vehicle registered with an IVCS according to the present invention.

FIG. 6 shows preformatted message text for use in sending a message through the IVCS according to the present invention.

Similar reference characters denote corresponding features consistently throughout the attached drawings.

### DETAILED DESCRIPTION OF THE PREFERRED EMBODIMENT(s)

The present invention is to a system and method for connecting an outgoing message of a first driver (“sender”) with a computer system of a second driver (“recipient”) who has been identified by the first driver only by visual identifying parameters pertaining to the second driver such as the vehicle license plate number, registration decal, or other identifying information.

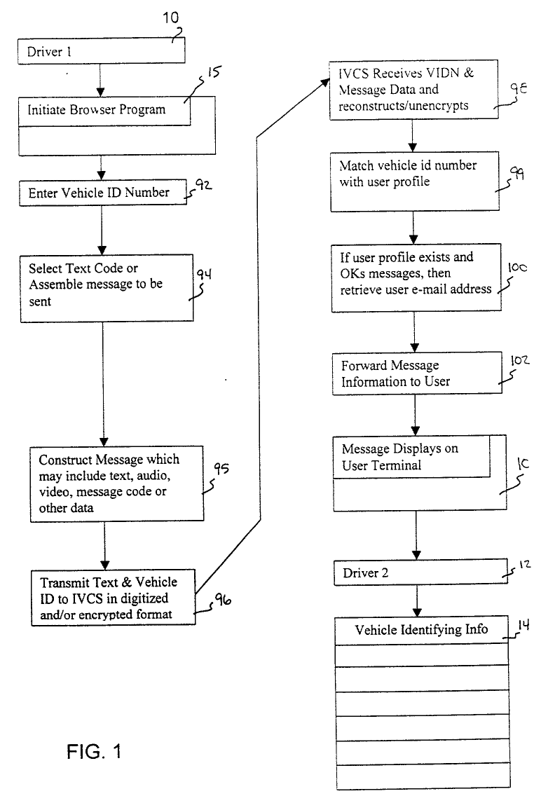

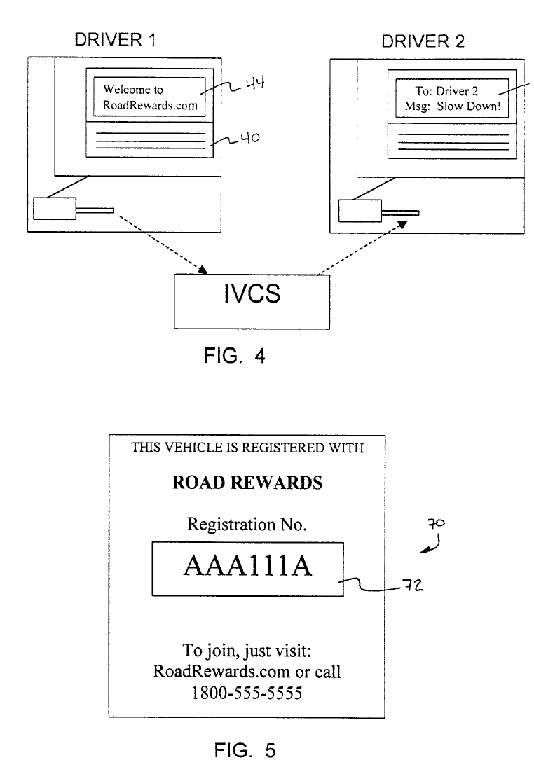

As shown in FIGS. 1 and 4, a first driver 10 operating a vehicle 11 observes a second driver 12 operating a vehicle 14 within his visual range and wants to e-mail a message to the second driver. The vehicle 14 has identifying information that is visually ascertainable such as the model, vehicle color, number of doors, license plate number and state. The vehicle may have additional information that is only ascertainable form up close or at certain angles such as a roof top identification number, vehicle identification number, or taxi badge number, etc. Additionally the vehicle may have other identifying information that is ascertainable through electronic broadcast or other methods. The information 16 is cumulatively the vehicle identifying information (“VII”).

A number of reasons may occur why the first driver would want to contact the second driver. For instance, the first driver may want to tell the second driver to slow down or that his tire is flat. Currently there is no method other than to flag down the driver or to beep at the driver until the driver pulls over to see why he is being flagged down. However, it is likely that the second driver will either fail to see or hear the signals, or fearing foul play of some kind will choose to ignore the signals and speed off without receiving the information which could be important or helpful to the driver.

Currently the only way that it is possible for the first driver (“sender”) to send information is if the sender recognizes the driver of the second vehicle (“recipient”) and already knows the e-mail address of the recipient, or at a minimum knows the name of the recipient and can find the recipient's address indexed by his name. The likelihood that the sender knows the driver at any random intersection or stretch of highway is extremely small. And the likelihood that the sender can track down the e-mail address on the web, if it is available at all or up to date, in time to send a useful warning message, while simultaneously paying attention to driving is even smaller.

According to the present invention, a service is provided on the internet which allows the first driver to easily send a message over the internet, by e-mail or similar form, to the second driver without having prior knowledge of the second driver's e-mail address, if the second driver is registered with an inter vehicle communication system (“IVCS”).

Registration

A central aspect of the current invention is the registration service to register users with an internet service. The registration satisfies at least two main goals of the service. First is the collection of correlation data on a user such as his name, address, e-mail address, license plate number, and/or other vehicle identification information. The second is to certify that the user wishes to receive information from an individual trying to forward the information to him.

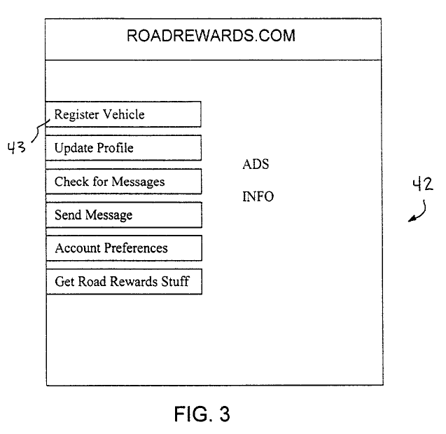

To initiate registration, as best shown in FIG. 1-5, a user logs onto the webpage (FIG. 3) of the Inter Vehicle Communication Services (“IVCS”). For an IVCS such as www.RoadRewards.com, the user types “RoadRewads.com” into a browser program 15 such as NETSCAPE™ or WINDOWS EXPLORER™ using his computer 40. It is to be understood that the particular computer used at any time is irrelevant, so long as the computer is internet capable and is logged onto a service provider such that it may send and receive e-mail addressed to the user. The webpage 42 (FIG. 3) is then presented on the computer monitor 44.

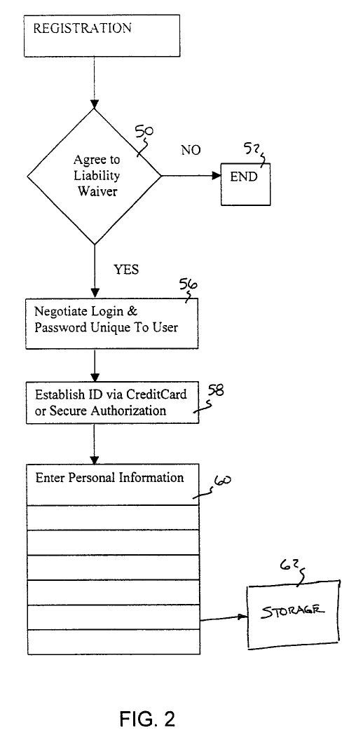

Once the user is logged onto the webpage 42, the user selects “register vehicle” to initiate the log on process. The “register vehicle” button 43 may be graphical, hypertext, hyperlinked, or otherwise programmed to send the user to the registration page. The registration page may be graphical or text based. FIG. 2 shows a flow diagram representing the registration steps for a preferred registration process. Once at the registration page, the user is queried 50 whether or not he agrees to a waiver of liability. This is preferred so that the IVCS does not have to control the content or transmission of information between the parties. If the user does not agree, then the webpage ends 52 the registration process and sends the user out of the registration process back to the main page 42.

If the user agrees to waive liability against the service, then the user negotiates a unique login name and password process 56 for future access and registration to the system. This process is well known to one of ordinary skill in the art and will not be described further. If the user signs onto the webpage again, the user can be matched with his profile and rights by re-entering the id and password, or by automatic identification through the use of internet cookies or other methods.

After establishing the login and password, the user must be authenticated 58 both to establish the true identity of the user and to limit “false” users which could clog the database with extraneous information. Authentication of the user may take any of several forms. Most commonly, the user enters his name and address information and authenticates himself by providing a credit card number which can be verified. However, other common means are now available and will soon be implemented which could be used as well. These methods include an independent internet verification source, a secure authorization site, or verification by an internet service provider.

Now that the user has been given a login identification and has been authenticated, the user can proceeds to the step 60 of entering personal data about himself and his vehicle. The following data are representative only and could include more or less data identifying the user and his vehicle:

Name,

address (work and/or home),

telephone number (work and/or home),

e-mail address,

webpage information,

vehicle type and

model,

vehicle color,

license plate number,

vehicular identification number (“VIN”).

The information could also include other types of visual or non-visual identifying numbers available to certain segments of the population such as police enforcement, truckers, specialized licensee such as taxi drivers, etc. This information could include:

Roof top identification numbers,

electronically transmitted identification numbers,

taxi badge numbers,

other information printed on the vehicle or carried by the vehicle.

In addition, the IVCS could issue identification numbers on decals (70, FIG. 5) placed in the window of the vehicle or otherwise affixed to the vehicle which identify the vehicle by a number or code 72 or mark which vehicles are members of the service. The code 72 could consist of number, letters, symbols or a combination thereof.

The IVCS then stores 62 the information into a database. The database records are linked such that a search by any one field can retrieve data linked to that field. For example, a search of the license plate 555AAA can retrieve the name of the user (e.g. “John Doe”) who registered the particular license plate. Various fields may be searched such as a entering a partial license plate along with color and type of vehicle to find a likely match, or the search may be only for the unique vehicle identification number to find the name of the registrant. Or instead of recalling the registrant's name, the database could present the e-mail address of the registrant or any other data found in the database.

Operation

In operation, a concerned person (“CP” or “sender”) 10 having access to a computer station 80 in a vehicle viewing a second vehicle 86 also having a computer station 84 desires to contact the driver of the second vehicle. As best shown in FIGS. 1 and 4, the CP initiates the browser program on his computer 88 and accesses the webpage of the IVCS such as RoadRewards.com (see FIG. 3) after pulling his vehicle off the road into a safe area (not shown). The CP then selects “send message” 90 from the graphical or text menu sending him into the routine shown in the flow diagram of FIG. 1.

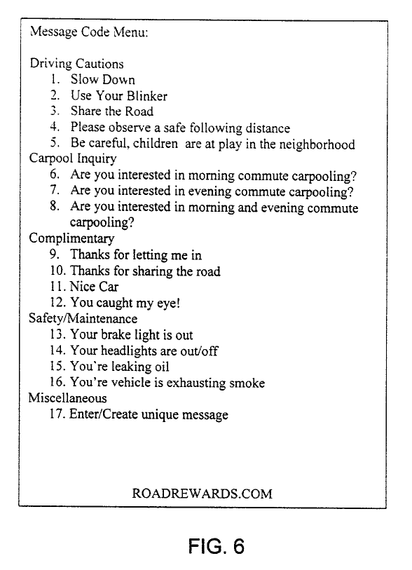

The CP is then prompted 92 for the license plate number of the vehicle that he wishes to contact, including the state designator for the plate, if necessary. The CP is then prompted 94 for the text of the message to be sent. Alternatively, the CP can choose from a table 96 (FIG. 6) of form messages that can be sent. The form messages may include those shown in FIG. 6. Thus if the CP enters code “3”, the message “Share the Road” is selected to be sent to the second vehicle 86. The message can also take the form of voice, audio, video, or other data which can be converted to a digital signal and sent as e-mail or an attachment to an e-mail, though text is preferred to maintain the size of the message at a minimal byte count.

The message is then digitized, converted, encrypted or otherwise prepared 95 for transmission 96 from the browser to the internet through the phone lines 97 connected to the vehicle. The message includes address information identifying the intended recipient solely by the license plate number or other vehicle identifying information (“VII”).

The IVCS receives the message or encrypted message and reconstructs 98 the message, including the address information. The IVCS then separates out the address information including the license plate number or VII. The IVCS compares 99 the license plate number or VII to member profiles in its database.

If the information matches the profile of a particular member, and the member profile authorizes the transmission of the information, then the IVCS retrieves 100 the e-mail address of the member 12 from the database and formats a new message addressed to the e-mail address of the registered member 12 and containing the original message information of the first driver's 10 message. The message is then forwarded 102 to the second driver for display 104 on the monitor 106 of the second driver's computer station.

The message may include a return address for the sender, so that a reply can be returned merely by hitting the “reply to” button on the message. One skilled in the art would also recognize that the message could be sent anonymously or by a non-returnable address. The message could be a general broadcast sent by a police officer or other official sending a warning message to speeders or an informational message such as “road closed ahead” or other message.

One skilled in the art would appreciate that the sender 10 could also be in a stationary position such as a house or yard or somewhere else where he can observe the vehicle and utilize the system according to the present invention without departing from scope and teaching of the present invention.

Additionally, in the case where both the sender 10 and recipient 12 are registered members of the IVCS, instead of forwarding the message as an e-mail, an “instant message” screen could be presented instead allowing for the instantaneous transmission of messages between the users on a split screen. The top screen preferably showing incoming messages and the bottom screen showing messages sent or under being typed for transmission. Preferably, voice communication between the two parties either through a web-based program or by hot linking the wireless communications systems supporting the modems of the computer browsers, the two parties can talk directly to each other. The preferred method of communication used will be dictated by the technology currently available -- modem speed, encryption methods, integration of computers and telephones, and standards currently in effect.

Revenue for the project will be provided preferably in two levels. A low level service will be available free of charge to the subscriber. The fees will be provided instead through advertisers to the site and links to travel related services or other marketers as appropriate. This level might only allow a subscriber to receive e-mail, chat, or instant messaging. By paying a subscription fee, the user would have access to other services such as filtering (based on key words or message codes) or voice communication, private e-mail address for use with IVCS or other services.

It is to be understood that the present invention is not limited to the sole embodiment described above, but encompasses any and all embodiments within the scope of the following claims.

We claim:

1. A method for directing an e-mail from a sender to a recipient comprising the steps of:
a. receiving a message from a sender including a license plate corresponding to the vehicle of the recipient;
b. matching the license plate of the recipient with an e-mail address of the recipient;
c. constructing an e-mail message addressed to the e-mail address of the recipient;
d. attaching the message from the sender to the e-mail message;
e. sending the e-mail message to the recipient's e-mail address.
